(19) United States
(12) Patent Application Publication
(10) Pub. No.: US 2026/0268864 A1
(43) Pub. Date: Sep. 10, 2026

(54) A METHOD AND SYSTEM FOR MANAGING BACKLIGHT UNIT FAILURE

(71) Applicant: Continental Automotive Technologies GmbH, Hannover (DE)

(72) Inventors: Ling Chih (Daniel) TENG, Singapore (SG); Kai Wen KIU, Singapore (SG); Hee Lee KOH, Singapore (SG); Audrey LIM, Singapore (SG)

(21) Appl. No.: 19/166,252

(22) PCT Filed: Feb. 29, 2024
(86) PCT No.: PCT/EP2024/055179

§ 371 Date: Sep. 17, 2025

(30) Foreign Application Priority Data
Mar. 22, 2023 (GB) 2304137.9

(51) Int. Cl. G09G 3/34; G09G 3/00

(52) U.S. Cl. CPC G09G 3/342; G09G 3/006; G09G 2300/026; G09G 2320/0626; G09G 2330/12; G09G 2380/10

(57) ABSTRACT

A method and system for managing displaying of content on a display apparatus in the event of failure of backlight unit. The method includes receiving a failure status signal identifying at least one defective illumination source within a malfunctioning illumination zone of a display apparatus and in response to the failure status signal received, a switching process is executed by a processing unit, of which the switching process includes switching a content displayed on a malfunctioning displaying zone to a functioning displaying zone and simultaneously, darkening the malfunctioning displaying zone. A switching condition for executing the switching process is defined by a type of content being displayed on the malfunctioning displaying zone, of which the type of content is further defined by a vehicular information.

### CROSS REFERENCE TO RELATED APPLICATIONS

This is a U.S. national stage of Application No. PCT/EP2024/055179 filed Feb. 29, 2024. Priority is claimed on Great Britain Application No. GB 2304137.9 filed Mar. 22, 2023, the contents of which are incorporated herein by reference.

### BACKGROUND OF THE INVENTION

### 1. Field of the Invention

This disclosure relates to a display management system, in particular a system for detecting and responding to backlight unit failures. More in particular, the display management system is implemented in a motor vehicle.

### 2. Description of the Related Art

Typical liquid crystal display requires a backlight module to provide illumination to the display layer such that content being displayed can be viewed by users. In automotive industry, display apparatus or display systems are mainly used for displaying information to vehicle operator.

In the event of backlight unit failure, vehicle display systems usually turn off an entire backlight unit as any defective LED is deemed to create an open circuit in the circuitry of a backlight unit. If the content displayed contains critical information, turning off the backlight unit prevents contents to be displayed and thus, safety of the vehicle operator and other road users may become an issue.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY OF THE INVENTION

A purpose of this disclosure is to ameliorate the problem of undesirable shutting down of backlight unit in vehicle display apparatus.

One aspect of this disclosure is a method of managing displaying a content on a display apparatus in the event of failure of backlight unit of the display apparatus, of which the method comprises:
receiving, by way of a processing unit, a failure status signal identifying a malfunctioning displaying zone of a display apparatus; and
in response to the failure status signal received by the processing unit, the method further comprises a switching process for:
   switching a content displayed on the malfunctioning displaying zone to a functioning displaying zone;
and simultaneously,
   darkening the malfunctioning displaying zone, characterized by that:
a switching condition for executing the switching process for the content displayed from the malfunctioning displaying zone to the functioning displaying zone is defined by
identifying a type of content being displayed on the malfunctioning displaying zone; and
determining, the malfunctioning displaying zone is caused by an open circuit status within a malfunctioning illumination zone corresponding to the malfunctioning displaying zone.

An advantage of the above-described aspect of this disclosure yields a method of managing content being displayed on a display apparatus, in particular a vehicle display apparatus, in the event of at least one defective LED in the backlight unit occurs, thus creating an open circuit status, thereby turning—off the entire backlight unit, which cuts-off displaying of contents on the display apparatus. More advantageously, the method disclosed herein executes a switching process in response to the failure status of the at least one defective LED in the backlight unit by identifying a functioning displaying zone having an illumination source which is functioning, and switching the contents being displayed on the malfunctioning displaying zone to a functioning displaying zone. The switching condition is defined by whether the contents being displayed on the malfunctioning displaying zone is a type of critical information, and whether the malfunctioning illumination zone is caused by an open circuit status. Consequently, the aforesaid method continues to display critical information to a vehicle operator in the event at least one defective illumination source in the backlight unit is detected.

Preferred is the method as described above or as described above as being preferred, in which the switching process further comprises:
transmitting, by way of the processing unit, an illumination control signal for darkening the malfunctioning illumination zone.

An advantage of the above aspect of this disclosure is to yield a transmission of signal from the processing unit to execute darkening of the malfunctioning illumination zone, to indicate to the vehicle operator the content displayed is not a high priority or critical type of information.

Preferred is the method as described above or as described above as being preferred, in which:
an illumination control signal for darkening the malfunctioning illumination zone contains information for dimming the malfunctioning illumination zone.

An advantage of the above aspect of this disclosure is to yield a transmission of an illumination control signal from the processing unit to execute dimming of the malfunctioning illumination zone, to indicate to the vehicle operator the content displayed is not a critical type of information, or lower level of priority.

Preferred is the method as described above or as described above as being preferred, in which:
an illumination signal for darkening the malfunctioning illumination zone contains information for deactivating the malfunctioning illumination zone.

An advantage of the above aspect of this disclosure is to yield a transmission of an illumination control signal from the processing unit to execute deactivation of the malfunctioning illumination zone, such that no information is displayed to the vehicle operator.

Preferred is the method as described above or as described above as being preferred, in which:
identifying, by way of the processing unit, a functioning illumination zone available for supplying light beams through to the functioning displaying zone.

An advantage of the above aspect of this disclosure is to yield a switching process further comprising a step of identifying an alternative illumination zone which is a closed circuit, i.e. no defective LED such that light beams may be supplied from the backlight unit through to the display layer. Advantageously, this achieves the technical effect of identifying a functioning illumination zone.

Preferred is the method as described above or as described above as being preferred, in which the switching process further comprises:
transmitting, by way of the processing unit, an activation control signal for activating the functioning illumination zone identified, thereby supplying light beams through the functioning displaying zone.

An advantage of the above aspect of this disclosure is to activate the functioning illumination zone identified, to complete the process of switching content displayed from a malfunctioning displaying zone to a functioning displaying zone by activating the functioning illumination zone. Consequently, the switching process as disclosed herein achieve the objective of displaying critical information to the vehicle operator in the event of a defective LED in the backlight unit is detected.

Preferred is the method as described above or as described above as being preferred, in which the switching process further comprises:
identifying, by way of a content module, the type of content being displayed on the malfunctioning displaying zone is a vehicular information.

An advantage of the above aspect of this disclosure is to yield a method which ameliorate at least some of the problems as discussed above, to determine a type of content being displayed on the malfunctioning displaying zone.

Preferred is the method as described above or as described above as being preferred, in which the switching process further comprises:
transmitting, by way of the processing unit, to an illumination driver module at least
   an illumination control signal; and/or
   an activation control signal,
for controlling the malfunctioning illumination zone and/or the functioning illumination zone.

An advantage of the above aspect of this disclosure is to yield a method involving an illumination driver module for controlling different illumination zones of a backlight unit. Advantageously, this method achieves controlling multiple illumination zones of a backlight unit. This is particularly advantages for edge-lit backlight unit using strips of LEDs to define each illumination zone.

An objective of this disclosure is solved by a display apparatus backlight unit failure management system, in which:
a processing unit operable to receive a failure status signal to identify a malfunctioning displaying zone of a display apparatus; and
in response the to the failure status signal received by the processing unit, the processing unit is further operable to:
to switch a content displayed on the malfunctioning displaying zone to a functioning displaying zone; and simultaneously,
   darken the malfunctioning displaying zone.
      characterized in that:
a switching condition to execute the switching process of the content displayed from the malfunctioning displaying zone to the functioning displaying zone is defined by
   a type of content being displayed on the malfunctioning displaying zone as identified by the processing unit; and
   cause of the malfunctioning displaying zone is an open circuit status within a malfunctioning illumination zone corresponding to the malfunctioning displaying zone.

An advantage of the above-described aspect of this disclosure yields a display apparatus backlight unit failure management system for managing content being displayed on a display apparatus, in particular a vehicle display apparatus, in the event of at least one defective LED in the backlight unit occurs. Advantageously, the failure management system includes a switching process to switch the content being displayed on a displaying zone corresponding to the malfunctioning illumination zone according to a switching condition defined. In particular, the switching condition is defined according to whether (a) the content being displayed is a type of critical information and (b) whether the cause of illumination zone malfunctioning is due to at least one defective LED in the backlight unit, thus the illumination zone is assumed to be in an open circuit status. Consequently, the display apparatus is operable to continue displaying critical information to the vehicle operator, thus ensuring safety of the vehicle operator.

Preferred is the failure management system as described above or as described above as being preferred, in which:
the processing unit is further operable to transmit an illumination control signal to darken the malfunctioning illumination zone.

An advantage of the above aspect of this disclosure is to darken the malfunctioning illumination zone such that when viewed by the vehicle operator, the displaying zone corresponding to the malfunctioning illumination zone appears to be darker. This is useful when displaying area of the contents are switched with a content deemed to have lower priority as compared to critical information for operating the motor vehicle. Consequently, the critical information is displayed in a functioning displaying zone and the content deemed to have a lower priority is viewed as a darkened area by the vehicle operator.

Preferred is the failure management system as described above or as described above as being preferred, in which:
the processing unit is further operable to transmit an illumination control signal to deactivate the malfunctioning illumination zone.

An advantage of the above aspect of this disclosure is to turn off the malfunctioning illumination zone, such that no content is displayed through the display layer. Advantageously, this is a power saving mode.

Preferred is the failure management system as described above or as described above as being preferred, in which:
the processing unit is further operable to transmit an activation control signal to activate a functioning illumination zone, wherein the functioning illumination zone is operable to supply light beams through to the functioning displaying zone.

An advantage of the above aspect of this disclosure is to activate the functioning illumination zone identified, such that light beams may be supplied through to the function displaying zone, for displaying content of the critical information.

Preferred is the failure management system as described above or as described above as being preferred, in which:
the display apparatus further comprises a content module operable to identify the type of content being displayed on the malfunctioning displaying zone.

An advantage of the above aspect of this disclosure is to identify a type of content being displayed using a content module. More advantageously, determining the type of content being displayed enables the processing unit to decide whether switching process is required.

Preferred is the failure management system as described above or as described above as being preferred, in which:
the type of content comprises a vehicular information.

An advantage of the above aspect of this disclosure is to identify the type of content displayed at the malfunctioning illumination zone is a critical information which may potentially affect safety of a driver.

Preferred is the failure management system as described above or as described above as being preferred, in which:
an illumination driver module operable to transmit at least:
   an illumination control signal; and/or
   an activation control signal,
to control malfunctioning illumination zone and/or the functioning illumination zone.

An advantage of the above aspect of this disclosure yields a a system having an illumination driver module to control different illumination zones of a backlight unit.

An objective of this disclosure is solved by a computer program product comprising instructions to cause the system as disclosed above to execute the steps of the method disclosed above.

An advantage of the above described aspect of this disclosure yields a computer program for executing a switching process in response to a switching condition fulfilled, of which the switching condition is defined by a type of content being displayed on a malfunctioning displaying zone

An objective of this disclosure is solved by a computer-readable medium having stored on the computer program as disclosed herein.

An advantage of the above-described aspect of this disclosure yields a computer-readable medium for executing the computer program as disclosed.

Other objects, features and characteristics, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the non-limiting embodiments of the disclosure, are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a flowchart of a method of managing failure in backlight unit;

FIG. 2 is a system block diagram;

FIG. 3A is a display apparatus;

FIG. 3B is a display apparatus with displaying zones;

FIG. 4A is a display apparatus with at least one malfunctioning illumination source; and

FIG. 4B is a display apparatus with at least one malfunctioning illumination source.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

### DETAILED DESCRIPTION OF THE PRESENTLY PREFERRED EMBODIMENTS

Hereinafter, the term “processing unit” used herein may broadly encompass a general-purpose processor, a central processing unit (CPU), a microprocessor, a digital signal processor (DSP), a controller, a microcontroller, a state machine, and so forth. Under some circumstances, a “processing unit” may refer to an application specific integrated circuit (ASIC), a programmable logic device (PLD), a field programmable gate array (FPGA), etc. The term “processing unit” may refer to a combination of processing devices, e.g., a combination of a DSP and a microprocessor, a plurality of microprocessors, one or more microprocessors in conjunction with a DSP core, or any other such configuration. The “processing unit” may include a memory, for loading a sequence of instruction, causing the “processing unit” to perform steps of actions. The term “memory” should be interpreted broadly to encompass any electronic component capable of storing electronic information. The term “memory” may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. “Memory” is said to be in electronic communication with a processor if the processor can read information from and/or write information to the memory. Memory that is integral to a processor is in electronic communication with the processor. Henceforth, the term “processing unit” may also be taken to encompass “system on chip” (SoC) which uses a single integrated circuit (IC) chip that contains multiple resources, computational units, processors and/or cores integrated on a single substrate. A single SOC may contain circuitry for digital, analog, mixed-signal, and radio-frequency functions, as well as any number of general purpose and/or specialized processors (digital signal processors, modem processors, video processors, etc.), memory blocks (e.g., ROM, RAM, Flash, etc.). Unless otherwise specifically stated, the “processing unit” is not limited to any specific combination of hardware circuitry and software, nor to any particular source for the instructions executed by the processing unit.

Conventional backlight unit usually utilize light emitting diodes (LED) to supply illumination to the display layer and there are two main types of backlight units, one which is approximately the same size as the display layer and displaced adjacent to the display layer such that light beams can be supplied through to the display layer to display content to the user. Another type of backlight unit which is also known as edge-lit backlight unit refers to illumination sources which are provided along an edge of a display apparatus. In the context used herein, both types of backlight unit are applicable.

For clarity and brevity, the examples provided in the description herein uses edge-lit backlight unit failure to explain the malfunctioning of backlight unit in vehicle display apparatus, although it shall be understood by a skilled practitioner, the technical concept is applicable to both types of backlight units. A backlight unit failure may occur when at least one illumination source is deemed to malfunction, thereby creating an open circuit in the circuitry of a backlight unit.

In addition thereto, a backlight unit failure shall not be misunderstood or compared against display pixel failure, in terms of stuck and dead pixels, which occurs on the display layer, of which a stuck pixel refers to a dot on the display layer, which occurs when the stuck pixel is only displaying one of the three colours, i.e. red, green or blue. In contrast, a dead pixel is a pixel which does not receives power and thus appears a persistent small black or white dot at the displaying zone when viewed.

### Method 100

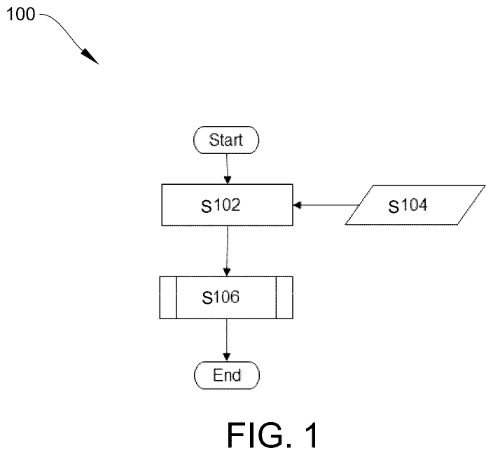

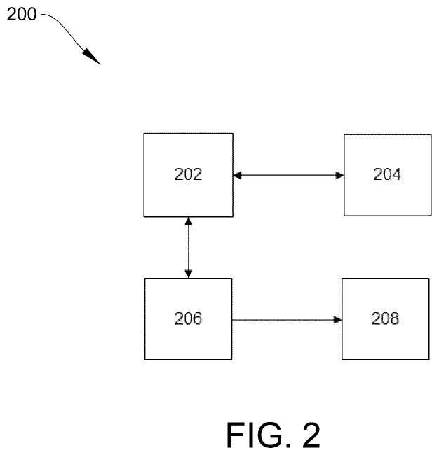

Referring now to FIG. 1 of the accompanying drawings which shows a flowchart illustrating a method 100 of managing displaying a content on a display apparatus in the event of failure of backlight unit of the display apparatus. At step S102, the method 100 comprises receiving a failure status signal for identifying at least one defective illumination source within a malfunctioning illumination zone of a display apparatus. The failure status signal is received by a processing unit (FIG. 2 referred).

At a step S104, a decision is made to determine a type of content being displayed on the malfunctioning displaying zone. The type of content being displayed may classified as high priority or critical information. In particular for vehicle applications, such as a vehicle display apparatus, high priority or critical information may include vehicle information and more in particular information related to vehicle operation, such as speed of vehicle, fuel or battery level or lane changing warning, but not limited thereto. In contrast, vehicle infotainment information such as FM radio station, climate setting, music style or audio level, are deemed as low priority or less critical information. The identification of type of content is determined by a content module. Determination of the type of content 104 being displayed on the malfunctioning displaying zone is a switching condition for triggering the switching process S106.

In response to the failure status signal received by the processing unit, the method further comprises a switching process S106. The switching process S106 further executes the steps of switching a content displayed on a malfunctioning displaying zone to a functioning displaying zone and simultaneously, darkening the malfunctioning displaying zone.

In addition to the example above, the switching process S106 further comprise a step of transmitting an illumination control signal for darkening the malfunctioning illumination zone. This step may be executable by a processing unit.

In an example, the illumination control signal for darkening the malfunctioning illumination zone contains information for dimming the malfunctioning illumination zone.

In another example, the illumination signal for darkening the malfunctioning illumination zone contains information for deactivating the malfunctioning illumination zone.

In addition to the example above, the switching process S106 further includes a step of identifying a functioning illumination zone available for supplying light beams through to the functioning displaying zone. This step may be executable by a processing unit.

In addition to the example above, the switching process S106 further includes a step of transmitting an activation control signal for activating the functioning illumination zone identified from previous step. This is to supply light beams through to the functioning displaying layer such that a content may be viewed by a viewer.

In addition to the example above, the switching process S106 further includes a step of transmitting to an illumination driver, at least an illumination control signal, and/or an activation control signal, for controlling the malfunctioning illumination zone and/or the functioning illumination zone.

All of the above steps may be executed by a processing unit, of which a set of programmable instructions is stored thereon in a memory.

### System 200

As shown in FIG. 2 is the backlight unit failure management system 200 which includes a processing unit 202, a content module 204, an illumination driver 206 and a backlight unit 208. As described in method 100 above, the switching process S106 may be executed by a processing unit 202. A content module 204 is operable to monitor an operational status of a display apparatus.

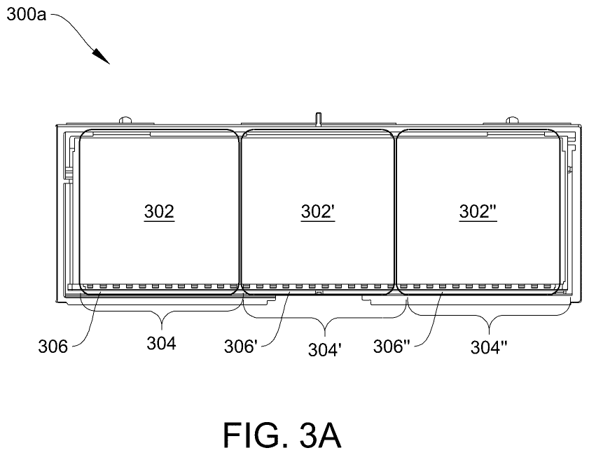

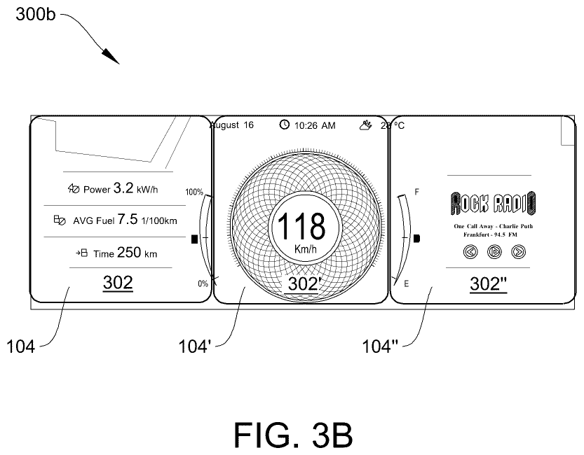

An illumination module 206 is operable to illuminate multiple illumination sources through different driving channels. By way of an example, in an edge-lit backlight unit 208, the illumination module 206 is operable to drive one or more illumination zones, each of the one or more illumination zones includes multiple illumination sources. In an example, each illumination zone is defined by a strip of LEDs. Each strip of LED may be referred to as a channel, of which the illumination module 206 is operable to drive each illumination channel to turn on or turn off the illumination zone (FIG. 3A referred).

In the event at least one defective light emitting diode (LED) or an illumination source in the backlight unit 208 is detected, the content module 204 is operable to send feedback in the form of a failure status signal to the processing unit 202, indicating an open circuit status or no current following through the channel with the at least one defective illumination source. The failure status signal may be transmitted through standard electrical communication bus protocol such as 12C or SPI.

FIG. 3A shows a display apparatus 300a in accordance with an exemplary aspect. As shown in FIG. 3A, the display apparatus 300a is defined into three displaying zones 302, 302′, 302″ but not limited thereto. Each of the displaying zones 302, 302′, 302″ has a corresponding illumination zone 304, 304′, 304″. Each illumination zone 304, 304′, 304″ includes multiple LEDs or illumination sources 306, 306′, 306″.

FIG. 3B shows a display apparatus 300b with multiple displaying zones in accordance with an exemplary aspect. Each of the displaying zones 302, 302′, 302″ defined by the corresponding illumination zone 304, 304′, 304″ is operable to display different type of content 104, 104′, 104″. As shown in FIG. 3B, there are three displaying zones 302, 302′, 302″, with displaying zone 302 displaying vehicle information pertaining to power, average fuel level, time taken to complete planned journey and displaying zone 302′ displaying vehicle speed, while displaying zone 302″ displays audio information. As described above, a switching condition for executing the switching process S106 from method 100 is defined by a type of content 104 that is being displayed at the malfunctioning displaying zone.

A main advantage of this disclosure is the concept of managing content being displayed on a display apparatus, in particular a vehicle display apparatus, in the event of at least one defective LED in the backlight unit occurs. When at least one defective LED is present in the backlight unit, an open circuit status is created and thus no current flows through the backlight unit or the illumination zone defined by illumination sources where the defective LED is present. This disclosure proposes a switching process in response to the failure status of the at least one defective LED in the backlight unit by identifying a functioning displaying zone having an illumination source which is functioning, and switching the contents being displayed on the malfunctioning displaying zone to a functioning displaying zone. The switching condition is defined by whether the contents being displayed on the malfunctioning displaying zone is a type of critical information, and whether the malfunctioning illumination zone is caused by an open circuit status. Consequently, critical information such as vehicle information is still displayed to a vehicle operator in the event at least one defective illumination source in the backlight unit is detected. Therefore, safety issue of the vehicle operator is addressed.

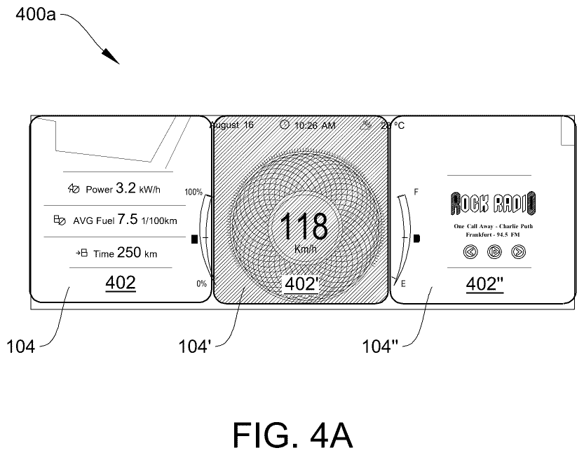

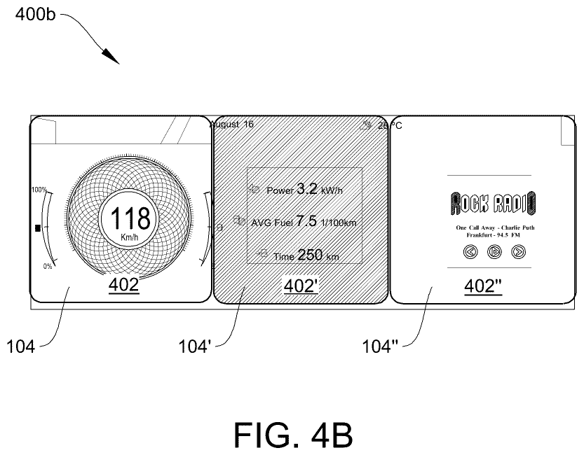

FIG. 4A shows a display apparatus 400a with at least one malfunctioning illumination source. In this example, the display apparatus 400a includes displaying zone 402, 402′, 402″, of which displaying zone 402′ has a malfunctioning illumination zone displaying a type of content 104′, which shows a critical information, more in particular, vehicle speed of the motor vehicle.

Applying the switching process S106 executable by the processing unit 202, FIG. 4B shows a display apparatus 400b with at least one malfunctioning illumination source, where the content module 204 determines a functioning displaying zone 402 with medium or low priority information being displayed is functioning. The malfunctioning illumination zone comprising the at least one malfunctioning illumination source is darkened such that the content 104 being displayed at displaying zone 402′ appears to be dimmer when viewed by the vehicle operator. Simultaneously, the processing unit 202 switches the critical information or content 104′ displayed at malfunctioning displaying zone 402′ to the functioning displaying zone 402.

The foregoing description shall be interpreted as illustrative and not be limited thereto. One of ordinary skill in the art would understand that certain modifications may come within the scope of this disclosure. Although the different non-limiting embodiments are illustrated as having specific components or steps, the embodiments of this disclosure are not limited to those combinations. Some of the components or features from any of the non-limiting embodiments may be used in combination with features or components from any of the other non-limiting embodiments. For these reasons, the appended claims should be studied to determine the true scope and content of this disclosure.

1.-17. (canceled)

18. A method of managing displaying content on a display apparatus in an event of failure of a backlight unit of the display apparatus, the method comprising:
receiving, by way of a processing unit, a failure status signal identifying at least one defective illumination source within a malfunctioning illumination zone of a display apparatus; and
initiating a switching process in response to the failure status signal received by the processing unit, configured to:
switching a content displayed on a malfunctioning displaying zone to a functioning displaying zone; and
simultaneously, darkening the malfunctioning displaying zone,
wherein a switching condition for executing the switching process for switching the content from the malfunctioning displaying zone to the functioning displaying zone is based on a type of content being displayed on the malfunctioning displaying zone.

19. The method according to claim 18, wherein the switching process further comprises:
transmitting, by way of the processing unit, an illumination control signal for darkening the malfunctioning illumination zone.

20. The method according to claim 19, wherein
the illumination control signal for darkening the malfunctioning illumination zone contains information for dimming the malfunctioning illumination zone.

21. The method according to claim 19, wherein
the illumination control signal for darkening the malfunctioning illumination zone contains information for deactivating the malfunctioning illumination zone.

22. The method according to claim 18, wherein the switching process further comprises:
identifying, by way of the processing unit, a functioning illumination zone available for supplying light beams through to the functioning displaying zone.

23. The method according to claim 22, wherein the switching process further comprises:
transmitting, by way of the processing unit, an activation control signal configured to activate the functioning illumination zone identified, thereby supplying light beams through the functioning displaying zone.

24. The method according to claim 18, wherein the switching process further comprises:
identifying, by way of a content module, whether the type of content being displayed on the malfunctioning displaying zone is a vehicular information.

25. The method according to claim 18, wherein the switching process further comprises:
transmitting, by way of the processing unit, to an illumination driver module at least one of:
an illumination control signal; and
an activation control signal,
configured to control the malfunctioning illumination zone and/or a functioning illumination zone.

26. A display apparatus backlight unit failure management system comprising:
a processing unit configured to receive a failure status signal to identify a malfunctioning displaying zone of a display apparatus (300a, 300b, 400a, 400b); and
in response to the failure status signal received by the processing unit, the processing unit is further configured to:
switch a content displayed on the malfunctioning displaying zone to a functioning displaying zone;
and simultaneously darken the malfunctioning displaying zone,
wherein:
a switching condition to execute a switching process to switch the content displayed from the malfunctioning displaying zone to the functioning displaying zone is defined by:
a type of content being displayed on the malfunctioning displaying zone as identified by the processing unit; and
a cause of the malfunctioning displaying zone is an open circuit status within a malfunctioning illumination zone corresponding to the malfunctioning displaying zone.

27. The failure management system according to claim 26, wherein
the processing unit is further configured to transmit an illumination control signal to darken the malfunctioning illumination zone.

28. The failure management system according to claim 26, wherein
the processing unit is further configured to transmit an illumination control signal to deactivate the malfunctioning illumination zone.

29. The failure management system according to claim 26, wherein
the processing unit is further configured to transmit an activation control signal to activate a functioning illumination zone, wherein the functioning illumination zone is configured to supply light beams through to the functioning displaying zone.

30. The failure management system according to claim 26, wherein the display apparatus further comprises a content module configured to identify the type of content being displayed on the malfunctioning displaying zone.

31. The failure management system according to claim 30, wherein the type of content (104, 104′) comprises a vehicular information.

32. The failure management system according to claim 26, wherein the system further comprises:
an illumination driver module configured to transmit at least one of:
an illumination control signal; and
an activation control signal,
to control malfunctioning illumination zone and/or the functioning displaying zone.

33. A computer program product stored on a nontransient computer readable media comprising instructions to cause a failure management system of a display apparatus claims to execute a method comprising:
receiving, by way of a processing unit, a failure status signal identifying at least one defective illumination source within a malfunctioning illumination zone of a display apparatus; and
initiating a switching process in response to the failure status signal received by the processing unit, configured to:
switching a content displayed on a malfunctioning displaying zone to a functioning displaying zone; and
simultaneously, darkening the malfunctioning displaying zone,
wherein a switching condition for executing the switching process for switching the content from the malfunctioning displaying zone to the functioning displaying zone is based on a type of content being displayed on the malfunctioning displaying zone.
